(19) United States
(12) Patent Application Publication
(10) Pub. No.: US 2025/0392202 A1
(43) Pub. Date: Dec. 25, 2025

(54) METHOD FOR CONTROLLING SWITCHES OF A MULTIPLE ACTIVE BRIDGE CONVERTER

(71) Applicants: COMMISSARIAT À L'ENERGIE ATOMIQUE ET AUX ENERGIES ALTERNATIVES, PARIS (FR); UNIVERSITE GRENOBLE ALPES, SAINT MARTIN D'HERES (FR); CENTRE NATIONAL DE LA RECHERCHE SCIENTIFIQUE, PARIS (FR); INSTITUT POLYTECHNIQUE DE GRENOBLE, GRENOBLE CEDEX (FR)

(72) Inventors: Rebecca TARRAF, GRENOBLE (FR); Sébastien CARCOUET, GRENOBLE (FR); David FREY, SAINT MARTIN D'HERES (FR); Sylvain LEIRENS, GRENOBLE (FR); Xavier MAYNARD, GRENOBLE (FR)

(21) Appl. No.: 19/228,650

(22) Filed: Jun. 4, 2025

(30) Foreign Application Priority Data
Jun. 10, 2024 (FR) 2406122

(51) Int. Cl. H02M 1/00; H02M 1/14; H02M 3/335

(52) U.S. Cl. CPC H02M 1/0058; H02M 1/0043; H02M 1/143; H02M 3/33515; H02M 3/33576

(57) ABSTRACT

The invention relates to a method for controlling switches of a multiple active bridge converter, the method comprising the steps of: a) scanning between 0 and π of the value of the internal phase shift (α₁) of a port, called reference port, and, for each value of the internal phase shift (α₁) of the reference port, carrying out the following sub-steps of: a1) computing, for each of the n−1 ports different from the reference port, the internal phase shift (αᵢ); a2) computing, for each of the n−1 ports different from the reference port, the external phase shift (φᵢ); a3) computing a set of at least one power parameter comprising the total losses (P_{total losses}) of the converter and, optionally, the number of switches of the converter in the ZVS condition; a4) determining an optimized value of the internal phase shift (α_{1,OPT}) of the reference port; b) updating the switching controls for the switches.

### CROSS-REFERENCE TO RELATED APPLICATION

This application claims priority to foreign French patent application No. FR 2406122, filed on Jun. 10, 2024, the disclosure of which is incorporated by reference in its entirety.

### FIELD OF THE INVENTION

The invention is in the field of power electronics, and in particular the field of DC/DC conversion. The invention relates to a method for controlling switches of a multiple active bridge converter (also called Multi-port Active-Bridge (MAB) converter).

### BACKGROUND

An MAB converter is an energy concentrator topology that has emerged in recent years. This multiport structure has recently attracted considerable attention, notably for applications requiring renewable energy sources and energy storage systems.

FIG. 1 illustrates an example of an MAB converter 1 connecting multiple sources (power grid 2, photovoltaic panel 3), loads 4 and an electrical energy storage system (accumulator 5) to a multiple winding transformer 6 through a plurality of DC/AC converters 7. Electricity consumption, production and storage occur in a single location, and with few conversion stages.

FIG. 2 illustrates the topology of the MAB converter in more detail.

Each port (Prt₁, Prt₂, . . . , Prtᵢ, . . . , Prtₙ) is made up of a voltage source (V₁, V₂, . . . , Vᵢ, . . . , Vₙ), which represents either an actual power source or a load behaving like a voltage source, and an H-bridge (Pnt₁, Pnt₂, . . . , Pntᵢ, . . . , Pntₙ), the operation of which is known to a person skilled in the art. Each H-bridge Pntᵢ is made up of four transistors (Tᵢ₁, Tᵢ₂, Tᵢ₃, Tᵢ₄).

Lᵢ represents the leakage inductance of the transformer winding of the port Prtᵢ, which can be connected to an external series inductor.

The MAB converter provides two-way power transfer, high efficiency and intrinsic electrical isolation.

The principle for controlling an MAB converter involves supplying each port Prtᵢ with the active power Pᵢ it needs at each instant.

The control system of an MAB converter with n ports requires n control outputs, which are the n active powers. In order to vary these outputs, the control inputs must be adjusted. As is known, an MAB converter has two types of control inputs: the internal phase shifts αᵢ and the external phase shifts φᵢ. The inputs and outputs of the control system are illustrated in FIG. 3.

The power of the reference port is not controlled because it is determined by the law of power conservation: the sum of the powers entering the MAB converter is equal to the sum of the powers leaving said converter. Therefore, the number of control outputs becomes (n−1) for an MAB with n ports.

FIG. 4 illustrates the AC voltages on a reference port, for example the first port Prt₁, and a port Prtᵢ, over a switching period Tₛ, with the internal and external phase shifts.

By convention, the external phase shift of a port, called reference port, is considered to be zero (φ₁=0). Therefore, all the other ports are offset relative to this port. The external phase shift between the port Prtᵢ and the port Prtᵢ is denoted φᵢⱼ=φᵢ−φⱼ. The internal phase shift of a port Prtᵢ is denoted αᵢ.

It can be seen that the switching instants of a port Prtᵢ can be expressed as a function of its internal and external phase shifts using the following relationship:

$${τ}_{i 1} = ( {φ}_{1 i} + \frac{{α}_{i}}{2} ) \cdot \frac{{T}_{s}}{2 π}$$

$${τ}_{i 2} = \frac{{T}_{s}}{2} + ( {φ}_{1 i} - \frac{{α}_{i}}{2} ) \cdot \frac{{T}_{s}}{2 π} ,$$

where
Tₛ corresponds to the switching period of the converter (Tₛ=1/fₛ).

Thus, having determined the internal phase shift and the external phase shift of a port, it is possible to compute the switching instants of the switches of each port.

Determining the internal phase shift αᵢ and the external phase shift φᵢ for each port amounts to solving a system of (n−1) equations with (2n−1) unknowns, which generates an infinite number of solutions.

A first technique for determining the control in an MAB converter involves applying EPS (External Phase Shift) modulation, notably described in the article by [Galeshi], in which the internal phase shift αᵢ is considered to be zero for all the ports. This technique has the advantage of offering a single solution (system of n equations with n unknowns), and is effective when the converter is operating at rated power. However, efficiency is not optimal at low power.

A second technique for determining the control in an MAB converter, notably described in the article by [Hebala], involves varying the internal phase shift αᵢ and detecting a local minimum of the RMS current in the transformer (“disturb and observe”). The disturbance is applied to the converter in real-time, without studying a mathematical model. This technique is simple to implement, and adding ports does not increase the complexity or the computation time. However, only RMS currents are taken into account; thus, this technique only considers the conduction losses of the system. More generally, stopping at the first local minimum does not provide an optimized solution.

A third technique for determining the control in an MAB converter, notably described in the article by [Dey], involves creating a generic mathematical model that takes into account all the variables in the system. This technique requires significant computing power. Thus, the modelling is performed “offline” (prior to conversion), and then the optimal values for the internal and external phase shifts are stored in a table. During conversion, the closest points are extracted from the table in real-time. Under actual conditions, it is not possible to store all the points, so the extraction is performed on values close to the actual points; thus, the values of the internal and external phase shifts can be sub-optimal.

Therefore, a requirement exists for providing a method for controlling an MAB converter that maintains high efficiency at low power and that can determine optimal phase shift values in real-time.

### SUMMARY OF THE INVENTION

Therefore, an aim of the invention is a method for controlling switches of a multiple active bridge converter comprising n ports, the method comprising the steps of:
a) scanning between 0 and in of the value of the internal phase shift of a port, called reference port, and, for each value of the internal phase shift of the reference port, carrying out the following sub-steps of:
a1) computing, for each of the n−1 ports different from the reference port, the internal phase shift by applying a condition for eliminating the exchange of reactive power between the ports, based on the voltage measured at the terminals of the ports;
a2) computing, for each of the n−1 ports different from the reference port, the external phase shift based on constraints on desired power values on each of said n−1 ports different from the reference port;
a3) computing a set of at least one power parameter comprising the total losses of the converter and, optionally, the number of switches of the converter in the ZVS condition;
a4) determining an optimized value of the internal phase shift of the reference port, with said optimized value corresponding to an overall extremum of the set of at least one power parameter;
b) updating the switching controls for the switches as a function of the optimized values of the internal phase shift and of the external phase shift of all the ports, with the optimized values of the internal phase shift and of the external phase shift (φ_{i,OPT}) being computed based on the optimized value of the internal phase shift of the reference port.

Advantageously, the total losses of the converter correspond to the sum of the conduction losses on all the ports of the converter and of the switching losses on all the ports of the converter.

Advantageously, the set of at least one power parameter only corresponds to the total losses of the converter, the optimized value of the internal phase shift of the reference port corresponds to a local minimum of the total losses of the converter.

Advantageously, the set of at least one power parameter corresponds to the total losses of the converter and to the number of switches of the converter in the ZVS condition, the optimized value of the internal phase shift of the reference port corresponds to a maximum of the number of switches of the converter in the ZVS condition.

Advantageously, if there are at least two maxima of the number of switches of the converter in the ZVS condition, the optimized value of the internal phase shift of the reference port corresponds to a local minimum of the total losses of the converter, from among the at least two maxima of the number of switches of the converter in the ZVS condition.

Advantageously, the method comprises, between sub-steps a2) and a3), a sub-step a21) comprising detecting at least one external phase shift with a value that is strictly greater than 37°, with the method not comprising a step of updating the switching instants of the switches if at least one external phase shift with a value that is strictly greater than 37° is detected.

Advantageously, the method comprises a step a0) of resetting the value of the internal phase shift of all the ports to zero and of assigning an external phase shift value that is computed by external phase shift modulation.

Advantageously, the optimized values of the external phase shift are transmitted to a proportional integral controller before step b).

Advantageously, the condition for eliminating the exchange of reactive power between two ports is defined by the following formula:

$$\frac{{V}_{i}}{{n}_{1 i}} \cdot cos ( \frac{{α}_{i}}{2} ) = \frac{{V}_{j}}{{n}_{1 j}} \cdot cos ( \frac{{α}_{j}}{2} ) ,$$

where
Vᵢ and Vⱼ respectively correspond to the DC voltage on the terminals of the ports i and j;
αᵢ and αⱼ respectively correspond to the internal phase shift of the ports i and j;
n₁ᵢ and n₁ⱼ respectively correspond to the turn ratio between the port i and the reference port, and to the turn ratio between the port j and the reference port.

Advantageously, the switching controls for the switches are updated provided that a change in voltage or a desired power value at the terminals of at least one of the ports has been detected.

Advantageously, the desired power values are determined based on a k-order generalized harmonic approximation model, and wherein k=7 for computing the total losses of the converter, and k=101 for computing the number of switches of the converter in the ZVS condition.

The invention also relates to a device for controlling switches of a multiple active bridge converter comprising n ports, the device being configured to:
a) scan between 0 and π of the value of the internal phase shift of a port, called reference port, and, for each value of the internal phase shift of the reference port, being configured to:
a1) compute, for each of the n−1 ports different from the reference port, the internal phase shift by applying a condition for eliminating the exchange of reactive power between the ports, based on the voltage measured at the terminals of the ports;
a2) compute, for each of the n−1 ports different from the reference port, the external phase shift based on constraints on desired power values on each of said n−1 ports different from the reference port;
a3) compute a set of at least one power parameter comprising the total losses of the converter and, optionally, the number of switches of the converter in the ZVS condition;
a4) determine an optimized value of the internal phase shift of the reference port, with said optimized value corresponding to an overall extremum of the set of at least one power parameter;
b) update the switching controls for the switches as a function of the optimized values of the internal phase shift and of the external phase shift of all the ports, with the optimized values of the internal phase shift and of the external phase shift being computed based on the optimized value of the internal phase shift of the reference port.

The invention also relates to a conversion system comprising a multiple active bridge converter and comprising n ports, and further comprising a control device as described above.

### BRIEF DESCRIPTION OF THE DRAWINGS

Further features, details and advantages of the invention will become apparent upon reading the description, which is provided with reference to the appended drawings, which are provided by way of an example.

FIG. 1, already described, illustrates an example of an MAB converter connected to various sources.

FIG. 2, already described, illustrates an MAB converter topology.

FIG. 3, already described, illustrates the inputs and outputs of the control of the MAB converter.

FIG. 4, already described, illustrates the AC voltage at the terminals of a port.

FIGS. 5 and 6 illustrate two flowcharts of the method according to the invention.

FIG. 7 illustrates the determination of an optimized value of the internal phase shift α_{1,OPT} according to a first embodiment.

FIG. 8 illustrates a Thevenin equivalent circuit of a port.

FIG. 9 illustrates the determination of an optimized value of the internal phase shift α_{1,OPT} according to a second embodiment.

FIG. 10 illustrates a diagram of the system capable of implementing the method according to the invention.

FIGS. 11 to 15 illustrate experimental results of the method according to the invention.

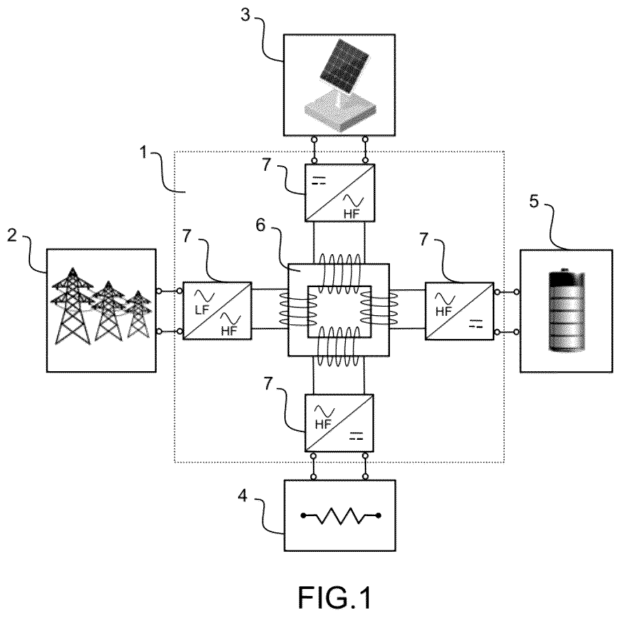

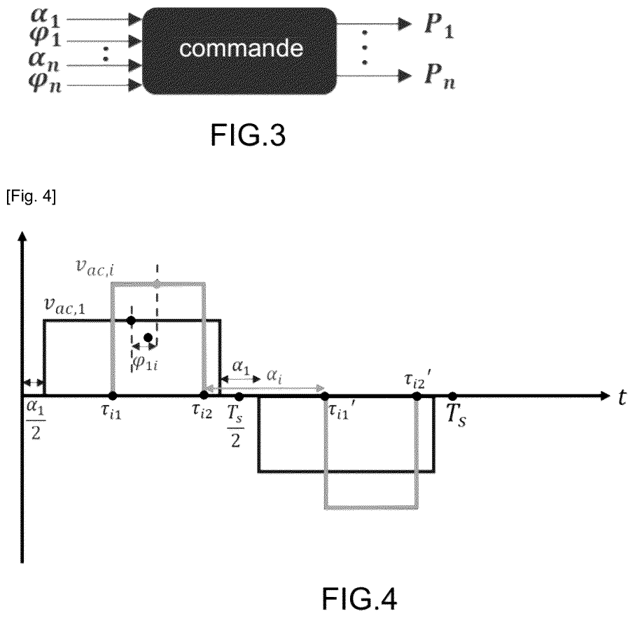

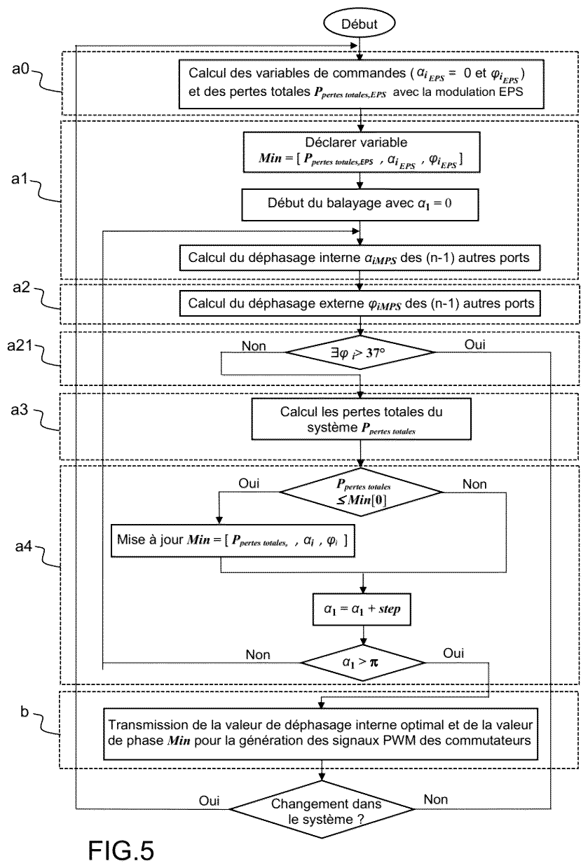

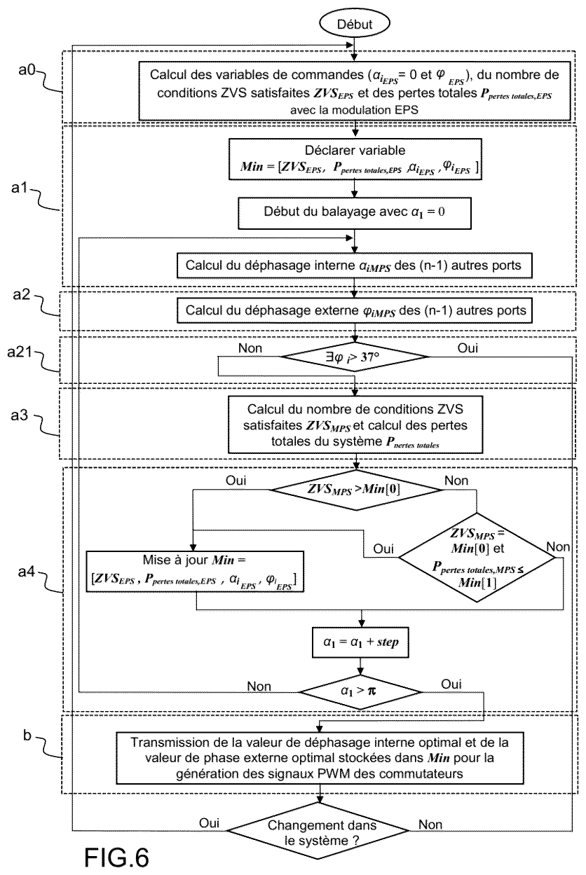

### DETAILED DESCRIPTION

The method according to the invention is based on scanning between 0 and π of the value of the internal phase shift α₁ of a port, called reference port, for example, the port Prt₁ (any other port can be defined as the reference port). The method is repeated for a plurality of values of the internal phase shift α₁. The repetition step can be predetermined and can be adjusted by the user, depending on the desired level of accuracy.

For each value of the internal phase shift α₁ of the reference port Prt₁, the internal phase shift α_{iMPS} of the other ports is computed by applying a condition for eliminating the exchange of reactive power between the ports, based on the voltage measured at the terminals of the ports.

According to one embodiment, the condition for eliminating the exchange of reactive power between the ports can be determined as follows.

Using the first harmonic approximation of the alternating signals of an MAB converter, it is possible to determine that the reactive power Qᵢⱼ exchanged between a port Prtᵢ and a port Prtⱼ is equal to:

$${Q}_{ij} = \frac{8}{{π}^{2} {L}_{ij} {ω}_{s}} \cdot [ {( \frac{{V}_{i}}{{n}_{1 i}} )}^{2} \cdot {cos}^{2} ( \frac{{α}_{i}}{2} ) - {( \frac{{V}_{j}}{{n}_{1 j}} )}^{2} \cdot {cos}^{2} ( \frac{{α}_{j}}{2} ) ] , \qquad \# ( 1 )$$

where
Vᵢ corresponds to the DC voltage of the port Prtᵢ;
ωₛ=2πfₛ and fₛ is the switching frequency of the converter.

$${L}_{ij} = \{ \begin{matrix}not applicable , & ∀ i = j \\ {L}_{i}^{′} + {L}_{j}^{′} + {L}_{i}^{′} {L}_{j}^{′} ( {\sum }_{k \neq i , j}^{n} \frac{1}{{L}_{k}^{′}} ) , & ∀ i \neq j\end{matrix} ,$$

where

$${L}_{i}^{′} = {L}_{i} / {n}_{1 i}^{2}$$

corresponds to the leakage inductance of a port Prtᵢ in relation to the reference port Prt₁, and n₁ᵢ=nᵢ/n₁ corresponds to the ratio of the number of turns between the port Prtᵢ and the reference port Prt₁.

When the reactive power flows in a converter, the circulating currents increase, as do the system losses. Therefore, minimizing the exchange of reactive power between the ports increases the efficiency of the system at certain operating points, particularly for light loads, because the ratio between the reactive power and the total apparent power is higher when the active power is low. From equation #(1), it can be deduced that the elimination of the exchange of reactive power between ports can be achieved by meeting the following equality:

$$\frac{{V}_{i}}{{n}_{1 i}} \cdot cos ( \frac{{α}_{i}}{2} ) = \frac{{V}_{j}}{{n}_{1 j}} \cdot cos ( \frac{{α}_{j}}{2} ) . \qquad \# ( 2 )$$

Obtaining equality #(1) also implies that the RMS values of the first harmonics of the AC voltage of the ports Prtᵢ and Prtⱼ are equal, which can be useful when there are voltage offsets, since the variations in DC voltages are thus compensated and soft switching thus can be restored.

From equation #(2), the internal phase shifts of the other ports can be deduced based on the value of the internal phase shift α₁ of the reference port Prt₁:

$${α}_{i} = 2 \cdot arccos ( \frac{{V}_{1}}{{V}_{i}} \cdot {n}_{1 i} \cdot cos ( \frac{{α}_{1}}{2} ) ) .$$

The DC voltages Vᵢ can be measured by measurement devices that are known to a person skilled in the art.

Similarly, for each value of the internal phase shift (α₁) of the reference port, and after computing the internal phase shifts of the other ports using the previous expression, the external phase shifts φᵢ of the non-reference ports are computed based on the constraints on the desired power values Pᵢ, using the following expression derived from the generalized harmonic approximation model:

$${P}_{i} = {\sum }_{\begin{matrix}j = 1 \\ j \neq i\end{matrix}}^{n} {P}_{j i}$$

given that:

$${P}_{ij} = \frac{4}{\begin{matrix}3 & \\ π & {f}_{s}\end{matrix}} \cdot {\sum }_{\begin{matrix}k = 1 \\ k odd\end{matrix}}^{∞} \frac{1}{{k}^{3}} . \frac{{V}_{i} {V}_{j}}{{n}_{1 i} {n}_{1 j}} \cdot \frac{1}{{L}_{ij}} cos ( k \frac{{a}_{i}}{2} ) \cdot cos ( k \frac{{a}_{j}}{2} ) \cdot ( k ( {Φ}_{1 j} - {Φ}_{1 i} ) )$$

where n is the total number of ports in the MAB and k is the harmonic order.

The method also comprises a sub-step of computing a set of at least one power parameter corresponding to the total losses (P_{total losses,MPS}) of the converter and, optionally, to the number of switches of the converter in the ZVS condition, for each value of the internal phase shift α₁ of the reference port Prt₁.

Thus, two embodiments can be contemplated.

According to a first embodiment, only the total losses of the converter are taken into account.

The total losses of the MAB converter are considered to be equal to the sum of the conduction losses P_{cond,i} and of the switching losses P_{sw,i} of all its ports. Any other losses, such as iron losses, are disregarded. Therefore, the total losses P_{total losses} can be computed as follows:

$${P}_{total losses} = {\sum }_{i = 1}^{n} {P}_{cond , i} + {\sum }_{i = 1}^{n} {P}_{sw , i} .$$

The conduction losses P_{cond,i} of a port Prtᵢ can be computed as follows:

$${P}_{cond , i} = ( {R}_{i} + 2 {R}_{ds , on} ) \cdot {I}_{i , rms}^{2} ,$$

where

Rᵢ corresponds to the series resistance at the port Prtᵢ and R_{ds,on} corresponds to the resistance of an activated switch, such that at most two switches are activated at a time in each port. I_{i,rms} is the RMS (Root Mean Square) value of the alternating current flowing through the port Prtᵢ, which is expressed by the following formula:

$${I}_{i , rms}^{2} = \frac{1}{{T}_{s}} {\int }_{0}^{{T}_{s}} {i}_{L , i}^{2} ( t ) dt$$

The expression for the total current i_{L,i} flowing from the port Prtᵢ to the other ports, related to its own side of the transformer, can be defined as follows:

$${i}_{L , i} ( t ) = {\sum }_{{j = 1}_{j \neq i}}^{n} \frac{{i}_{ij} ( t )}{{n}_{1 i}} ,$$

with

$${i}_{ij} ( t ) = \frac{1}{{L}_{ij}} {\int }_{0}^{t} ( {v}_{ac , i}^{′} ( t ) - {v}_{ac , j}^{′} ( t ) ) dt$$

with

$${v}_{ac , i}^{′} = {v}_{ac , i} / {n}_{1 i}$$

The switching losses P_{sw,i} of a port Prtᵢ are used to quantify the soft switching loss of the switches of each port. The switching losses P_{sw,i} are computed by first determining whether αᵢ>0 or whether αᵢ=0.

If αᵢ=0, the switching losses P_{sw,i} are computed as follows:

$${P}_{sw , i} = 2 \cdot {V}_{D} ( {τ}_{i 1} ) \cdot {I}_{D} ( {τ}_{i 1} ) \cdot {f}_{s} \cdot [ {t}_{ON} \cdot ( 1 - {ZVS}_{i 1} ) + {t}_{OFF} ] + 4 \cdot {P}_{{C}_{oss}} ( {τ}_{i 1} )$$

With the following variables:

$${V}_{D} ( {τ}_{ik} ) = {V}_{i}$$

$${I}_{D} ( {τ}_{ik} ) = \vert {i}_{L , i} ( {τ}_{ik} ) \vert$$

$${ZVS}_{ik} = \{ \begin{matrix}1 & if conditions 1 , 2 , and 3 are met at the instant {τ}_{ik} \\ 0 & otherwise\end{matrix}$$

| Internal phase shift | |
|---|---|
| value | Condition #1 concerning current direction |
| αᵢ > 0 | i_{L,i}(τᵢ₁) < 0 |
| | (τᵢ₂) > 0 |
| αᵢ = 0 | i_{L,i}(τᵢ₁) < 0 |
| Internal phase shift | Condition #2 concerning the minimum |
| value | current value |
| αᵢ > 0 | $\vert {i}_{L , i} ( {τ}_{i 1} ) \vert \geq \sqrt{2 \frac{{C}_{oss} {V}_{i}^{2}}{{L}_{th , i}} - 4 \frac{{C}_{oss} {V}_{th , i} ( {τ}_{i 1} ) {V}_{i}}{{L}_{th , i}}}$ |
| | $\vert {i}_{L , i} ( {τ}_{i 2} ) \vert \geq \sqrt{- 2 \frac{{C}_{oss} {V}_{i}^{2}}{{L}_{th , i}} + 4 \frac{{C}_{oss} {V}_{th , i} ( {τ}_{i 2} ) {V}_{i}}{{L}_{th , i}}}$ |
| αᵢ = 0 | $\vert {i}_{L , i} ( {τ}_{i 1} ) \vert \geq 2 \sqrt{- \frac{{C}_{oss} {V}_{th , i} ( {τ}_{i 1} ) {V}_{i}}{{L}_{th , i}}}$ |

| Internal | |
|---|---|
| phase | |
| shift | Condition #3 concerning the minimum switching |
| value | dead time value |
| αᵢ > 0 | ${t}_{di 1 , min} = \frac{1}{{w}_{r}} ( arccos ( - \frac{( {V}_{i} - {V}_{th , i} ( {τ}_{i 1} ) )}{{V}_{th , i} ( {τ}_{i 1} )} cos ( arc tan \frac{{A}_{i 1}}{{B}_{i 1}} ) ) - arc tan \frac{{A}_{i 1}}{{B}_{i 1}} )$ |
| | ${t}_{di 2 , min} = \frac{1}{{w}_{r}} ( arccos ( - \frac{{V}_{th , i} ( {τ}_{i 2} )}{( {V}_{i} - {V}_{th , i} ( {τ}_{i 2} ) )} cos ( arc tan \frac{{A}_{i 2}}{{B}_{i 2}} ) ) - arc tan \frac{{A}_{i 2}}{{B}_{i 2}} )$ |
| αᵢ = 0 | ${t}_{di 1 , min} = \frac{1}{{w}_{r}} ( arccos ( \frac{( {V}_{i} - {V}_{th , i} ( {τ}_{i 1} ) )}{( - {V}_{i} - {V}_{th , i} ( {τ}_{i 1} )} cos ( arc tan \frac{{A}_{i 1}}{{B}_{i 1}} ) ) - arc tan \frac{{A}_{i 1}}{{B}_{i 1}} )$ |

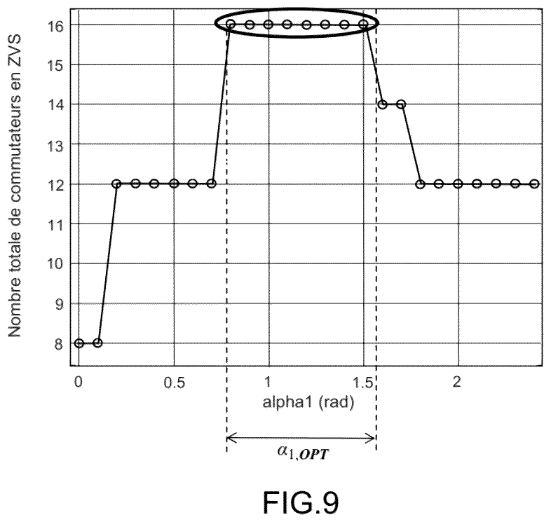

L_{th,i} are respectively the voltage and the inductance of the Thevenin equivalent scheme of a port Prtᵢ (see FIG. 9).

Aᵢ₁ and Bᵢ₁ are real constants computed based on the initial conditions at the switching instant i_{L,i}(0)=i_{L,i}(τᵢ₁) and vₓ(0)=0) and wᵣ=2πfᵣ with fᵣ being the resonant frequency of the LC circuit made up of the Thevenin inductance L_{th,i} and the parasitic capacitances.

The loss caused by charging/discharging the parasitic capacitance of a switch is computed as follows:

$${P}_{{C}_{oss}} = \frac{1}{2} \cdot {C}_{oss} \cdot {V}_{{C}_{oss} , final}^{2} \cdot {f}_{s} ,$$

where

Cₒₛₛ corresponds to the parasitic capacitance.

At the end of a switching instant, the final value of the voltage V_{C}_{ₒₛₛ}_{,final} of the parasitic capacitance Cₒₛₛ upon powering-up is therefore defined as follows:

$${V}_{{C}_{oss} , final} = \{ \begin{matrix}0 & for soft switching ( ZVS ) \\ {V}_{i} & for hard switching \\ Δ V & for incomplete soft switching\end{matrix}$$

Incomplete soft switching occurs when the capacitance of a switch of a port is not fully discharged when it is activated, thus leaving a residual voltage ΔV, the computation of which is not described in this description.

If αᵢ>0, the switching losses P_{sw,i} are computed as follows:

$${P}_{sw , i} = 2 \cdot [ {P}_{ON} ( {τ}_{i 1} ) + {P}_{OFF} ( {τ}_{i 1} ) + {P}_{ON} ( {τ}_{i 2} ) + {P}_{OFF} ( {τ}_{i 2} ) ] + 2 \cdot {P}_{{C}_{oss}} ( {τ}_{i 1} ) + 2 \cdot {P}_{{C}_{oss}} ( {τ}_{i 2} )$$

Reformulated as follows:

$${P}_{sw , i} = {V}_{D} ( {τ}_{i 1} ) \cdot ( {τ}_{i 1} ) \cdot {f}_{s} \cdot [ {t}_{ON} \cdot ( 1 - {ZVS}_{i 1} ) + {t}_{OFF} ] + {V}_{D} ( {τ}_{i 2} ) \cdot {I}_{D} ( {τ}_{i 2} ) \cdot {f}_{s} \cdot [ {t}_{ON} \cdot ( 1 - {ZVS}_{i 2} ) + {t}_{OFF} ] + 2 \cdot {P}_{{C}_{oss}} ( {τ}_{i 1} ) + 2 \cdot {P}_{{C}_{oss}} ( {τ}_{i 2} )$$

The switching instants τᵢ₁ a τᵢ₂ have been previously defined with reference to FIG. 4.

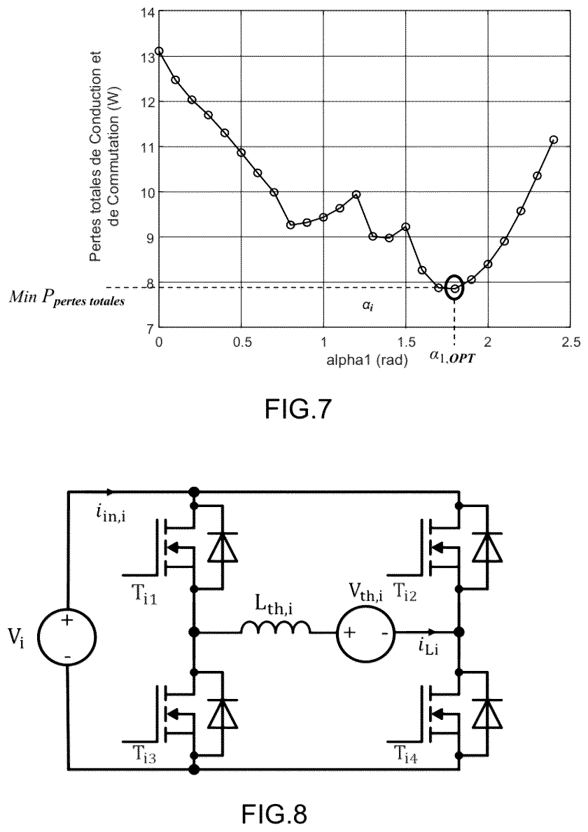

Once the total losses of the converter have been computed, the value of the internal phase shift α_{1,OPT} of the reference port for which the total losses of the converter are minimal is determined. FIG. 7 illustrates the total losses of the converter as a function of various values of the internal phase shift of the reference port at 60% of its rated power.

The simulation results in FIGS. 7 and 9 were obtained with a four-port MAB converter and the following parameters:

$${V}_{1} = 200 V$$

$${V}_{2} = 180 V$$

$${V}_{3} = 160 V$$

$${V}_{4} = 240 V$$

$$fs = 40 kHz$$

Rated power of each port=500 W

In the example in FIG. 7, it appears that the losses are minimal for α₁=1.8 rad. This value is the optimized value of the internal phase shift α_{1,OPT} of the reference port.

The external phase shift of the reference port and the internal and external phase shifts of the other ports are computed based on the optimized value of the internal phase shift of the reference port, using the formulas described above.

Thus, the number of degrees of control freedom of the MAB converter is reduced to n, where n is the total number of ports. The number of ports is greater than 2, and preferably strictly greater than 2. The remaining control parameters are the (n−1) external phase shifts of the ports other than the reference port and the internal phase shift of the reference port. Thus, the control method can be summarized as a system of (n−1) equations with n unknowns, which can be executed in real-time.

For this first embodiment, it is advantageous for k=7 to be set for the k-order generalized harmonic approximation, for computing the RMS current and conduction losses. This value represents a good compromise between accuracy and computation time.

According to a second embodiment, a set of at least one power parameter corresponding to the total losses of the converter and the number of switches of the converter in the ZVS condition is computed.

Thus, for each iteration of the internal phase shift α₁ of the reference port, the number of switches of the converter in the ZVS condition and the total losses of the converter are recorded.

The computation of the total losses of the converter is identical to the previous embodiment.

The determination of the soft switching condition (ZVS condition) is described in the above table that is described with reference to the first embodiment.

In the second embodiment, the choice of the optimal internal phase shift aims to maximize the number of switches in the ZVS condition while minimizing total losses as much as possible, whereas, in the first embodiment, the aim is to only minimize total losses, even if this leads to a smaller number of switches in the ZVS condition.

By way of a reminder, a switch is activated at zero voltage (ZVS) if its drain current is negative during its switching instant. This negative current flows through its anti-parallel diode, turning it on, hence the voltage drop on the switch. Consequently, in an ideal situation, the ZVS operation of a switch only depends on the direction of its current.

However, this condition is not sufficient in a practical converter. Indeed, this is because the parasitic capacitance Cₒₛₛ between the drain and the source of the switch has to have a minimum amount of energy passing through it during the switching instant in order to charge or discharge. Consequently, a minimum current must flow through each port during its switching instants, assuming that the imposed dead time is long enough for the exchange of energy to fully take place. This energy value can be computed using the Thevenin equivalent circuit of a port Prtᵢ shown in FIG. 8.

The voltage source V_{th,i} and the inductance L_{th,i} replace the remaining ports of the MAB converter and are computed based on the following formulas:

$${L}_{th , i} = \frac{1}{{\sum }_{{j = 1}_{j \neq i}}^{n} \frac{1}{{L}_{ij}}}$$

$${V}_{th , i} ( t ) = {\sum }_{j = 1 , j \neq 1}^{n} {v}_{ac , j} ( t ) \cdot \frac{{L}_{th , i}}{{L}_{ij}}$$

For each port, there are four switching instants in a switching period Tₛ. These instants are shown in FIG. 4. Since the current in each port is symmetrical from one half-cycle to the next, only two switching instants need to be studied for each port (τᵢ₁ and τᵢ₂).

At each of these instants, one switch is turned on and another switch is turned off. The switch that is activated is the switch on which the ZVS conditions are examined. A soft switch (ZVS) will result in almost zero switching losses.

FIG. 4 shows that the switching instants of a port can be expressed as a function of its phase shifts as follows:

$${τ}_{i 1} = ( {φ}_{1 i} + \frac{{α}_{i}}{2} ) \cdot \frac{{T}_{s}}{2 π}$$

$${τ}_{i 2} = \frac{{T}_{s}}{2} + ( {φ}_{1 i} - \frac{{α}_{i}}{2} ) \cdot \frac{{T}_{s}}{2 π}$$

With reference to the above table described for the first embodiment, in order to determine the ZVS condition a distinction is made depending on whether αᵢ>0 or αᵢ=0.

Thus, for each iteration of the method, i.e. for each value of the internal phase shift α₁ of the reference port, the number of transistors in the soft switching condition is determined.

FIG. 9 illustrates the evolution of the number of transistors in the soft switching condition as a function of the value of the internal phase shift α₁, for a given operating point where the power is equal to 60% of the rated power. The internal phase shift value with the maximum number of transistors in the soft switching condition is considered to be the optimal value of the internal phase shift α_{1,OPT} of the reference port (between 0.8 and 1.5 rad in FIG. 9).

For this second embodiment, it is advantageous for k=101 to be set (in the k-order generalized harmonic approximation) for computing the number of switches in the converter in the ZVS condition.

This value also offers a good compromise between accuracy and computation time. Greater accuracy is required for computing an instantaneous current than an RMS current, which explains why the optimal value of k is different compared to the first embodiment.

If several optimal values for the internal phase shift α_{1,OPT} have the same maximum number of transistors in the soft switching condition, a second test involves determining, from among the first set of values, the value for which the total losses are minimal.

For the ports other than the reference port, the optimized values of the internal phase shift α_{i,OPT} and of the external phase shift φ_{i,OPT} are determined based on the optimized value of the internal phase shift α_{1,OPT} of the reference port, according to the formulas introduced above.

The method comprises a final step that involves updating the switching controls of the switches as a function of the optimized values of the internal phase shift α_{i,OPT} and of the external phase shift φ_{i,OPT} of all the ports.

To this end, and in a manner known to a person skilled in the art, a microcontroller produces PWM control signals that are phase shifted relative to each other according to the optimal values obtained for the internal and external phase shifts.

The selection of the first (minimization of losses) or of the second (maximization of the switches in the ZVS condition) depends on the priorities set by the user.

If the priority is to maximize system efficiency, even if non-ZVS switching may occur on some switches, then the user may select the first embodiment, i.e. seek to have minimal total losses.

Conversely, if electromagnetic compatibility is a priority, it is more appropriate to implement the second embodiment.

When computing the external phase shift, it may be advantageous to detect, for each iteration of the internal phase shift α₁ of the reference port, whether the external phase shift has a value that is strictly greater than 37°. Indeed, above 37°, the difference between sin (φᵢ) and φᵢ becomes too great, and the approximation sin (φᵢ)=φᵢ, used to compute the output power of each port, is no longer considered to be valid (see [Galeshi]). If the external phase shift of one of the ports has a value that is strictly greater than 37°, the current increases in the MAB converter in a non-linear manner.

In this case, the method does not include a step of updating the control of the converter.

According to another advantageous embodiment, the method comprises a step of initializing the values of the total losses P_{total losses} of the converter, of the internal phase shift αᵢ and of the external phase shift φᵢ of each port.

The initial values can be determined using EPS (External Phase Shift) modulation, in which the internal phase shift αᵢ is considered to be zero for all the ports.

It also can be advantageous to implement the method for updating converter controls provided that a change in voltage on the terminals of at least one of the ports has been detected, thereby avoiding continuous use of the computational resources of the device for updating the control of the converter.

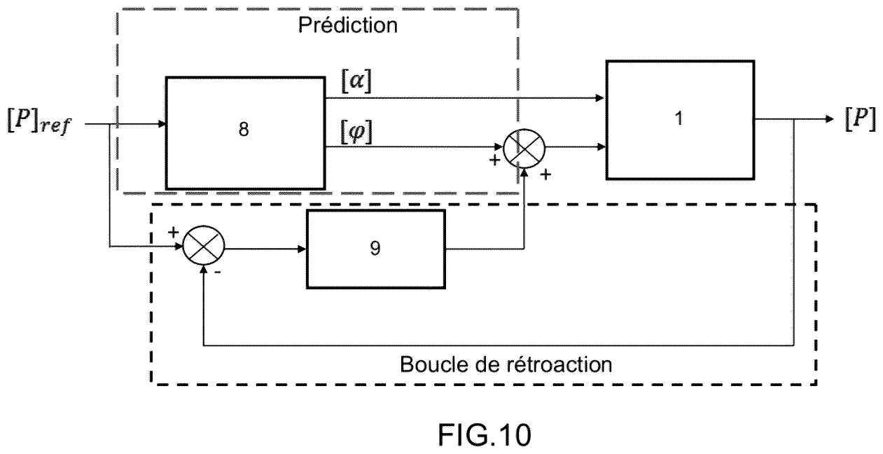

FIG. 10 illustrates a block diagram of the device 8 for controlling the switches of a multiple active bridge converter 1 according to the invention. The control device 8 transmits the internal phase shift values α_{i,OPT} to the MAB converter 1.

The control device 8 also allows the dynamic control of the various ports to be decoupled.

The power is measured at the various ports, and a closed loop with PI (Proportional Integral) controllers 9 is added in order to correct the static error caused by the uncertainty of the mathematical model and the values of the parameters of the actual converter. Proportional integral control is preferred due to its simplicity, but other controllers can be contemplated, provided that they can also correct the static error.

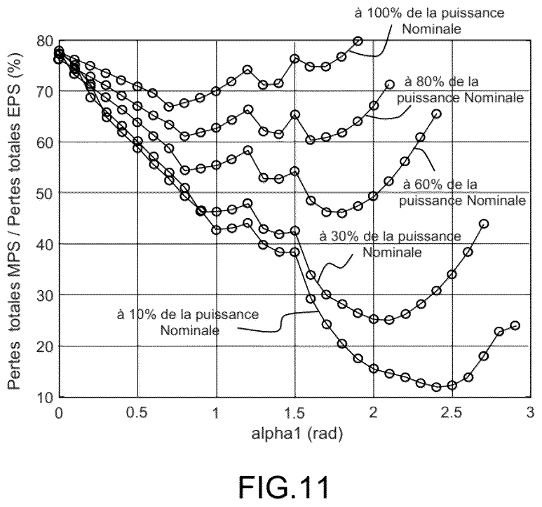

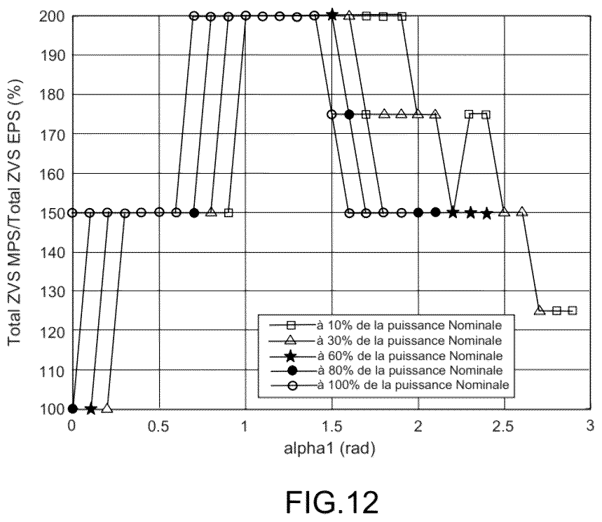

FIGS. 11 and 12 illustrate the total losses of the converter as a function of the value of the internal phase shift α₁ of the reference port, with a four-port MAB converter at different power levels.

FIG. 11 shows that using the method according to the invention reduces the total system losses compared to EPS modulation over its entire operating range, particularly at low power. Furthermore, for each operating point, a value exists for the internal phase shift α₁ of the reference port where these losses reach an overall minimum.

The presence of local minima in the total loss curve is caused by the saturation of certain internal phase shifts of the ports other than the reference ports. These values cannot be negative or greater than π in radians. The existence of local minima shows that a “Disturb and Observe” type algorithm cannot achieve optimal operation, as it would stop at the first local minimum.

FIG. 12 illustrates the number of switches in the ZVS condition with the method according to the invention, relative to the number of switches in the ZVS condition with an EPS modulation technique. The method according to the invention shows that it also allows the ZVS condition to be restored on certain switches. Furthermore, at all the power levels, the ZVS condition is achieved on all the switches of the ports at certain values of the internal phase shift α₁.

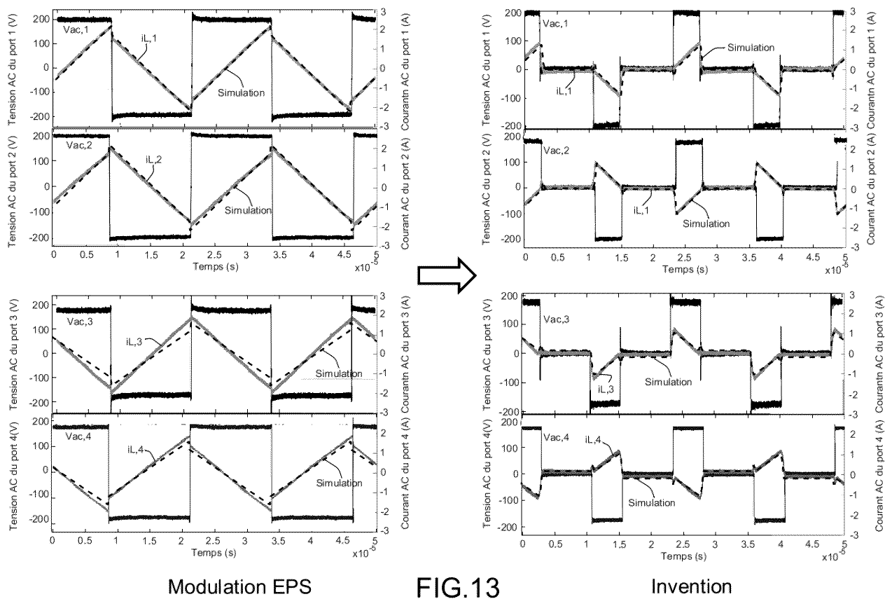

The left-hand side of FIG. 13 shows the experimental waveforms of the AC current and of the AC voltage on each port of a four-port MAB converter operating at 8% of its rated power, with EPS modulation that is known from the prior art. The right-hand side of FIG. 13 shows the same data with the method according to the invention.

In the simulation in FIG. 13, the average effective current flowing through each port at the selected operating point is I_{rms,i}=1.1 A when the EPS modulation is applied, and is reduced to I_{rms,i}=462.5 mA using the method according to the invention.

In other words, the RMS current is reduced by approximately 58% with the method according to the invention at this studied operating point. Furthermore, FIG. 13 shows that the ZVS condition is restored on the ports 3 and 4, and that the ZCS (Zero Current Switching) condition occurs on the stop switches with the method according to the invention. The peak AC currents are also reduced, resulting in less iron losses in the transformer and the inductors of the MAB converter.

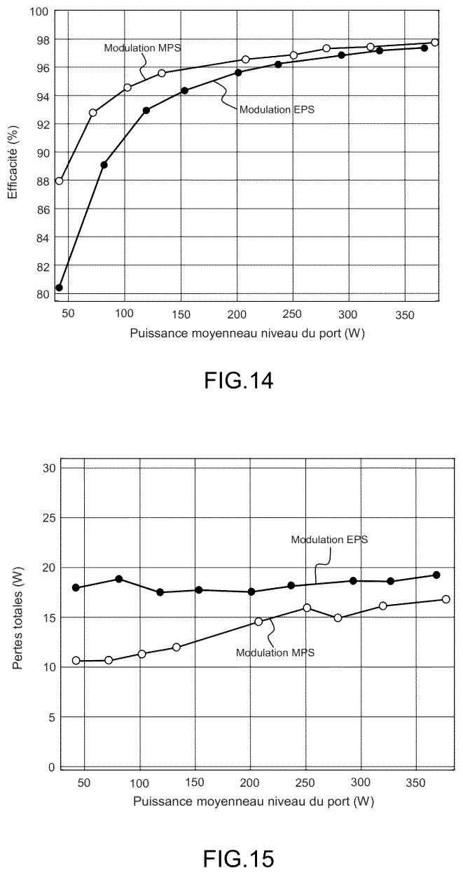

FIGS. 14 and 15 respectively illustrate the experimental efficiency and loss curves obtained with a four-port MAB converter at different power levels. It is possible to conclude that the proposed control strategy significantly reduces the total losses of the system, resulting in an increase in the total efficiency of the MAB converter over its entire operating range. This gain is particularly noticeable at operating points where low power flows through the MAB converter.

### CITED REFERENCES

[Galeshi] Soleiman Galeshi, David Frey, Yves Lembeye, “Efficient and scalable power control in multi-port active-bridge converters”, The 22nd European Conference on Power Electronics and Applications EPE' 20 ECCE Europe, September 2020, Lyon, France. 10.23919/EPE20ECCEEurope43536.2020.9215905, hal-03145571.
[Hebala] O. M. Hebala, A. A. Aboushady, K. H. Ahmed, and I. Abdelsalam, “Generalized Active Power Flow Controller for Multiactive Bridge DC-DC Converters With Minimum-Current-Point-Tracking Algorithm”, IEEE Trans. Ind. Electron., Vol. 69, No. 4, pp. 3764-3775, April 2022, doi: 10.1109/TIE.2021.3071681.
[Dey] S. Dey, A. Mallik, and A. Akturk, “Investigation of ZVS Criteria and Optimization of Switching Loss in a Triple Active Bridge Converter Using Penta-Phase-Shift Modulation”, IEEE J. Emerg. Sel. Topics Power Electron., Vol. 10, No. 6, pp. 7014-7028, December 2022, doi: 10.1109/JESTPE.2022.3191987.

1. A method for controlling switches of a multiple active bridge converter comprising n ports, the method comprising the steps of:
a) scanning between 0 and π of the value of the internal phase shift (α₁) of a port, called reference port, and, for each value of the internal phase shift (α₁) of the reference port, carrying out the following sub-steps of:
a1) computing, for each of the n−1 ports different from the reference port, the internal phase shift (αᵢ) by applying a condition for eliminating the exchange of reactive power between the ports, based on the voltage measured at the terminals of the ports;
a2) computing, for each of the n−1 ports different from the reference port, the external phase shift (φᵢ) based on constraints on desired power values (Pᵢ) on each of said n−1 ports different from the reference port;
a3) computing a set of at least one power parameter comprising the total losses (P_{total losses}) of the converter and, optionally, the number of switches of the converter in the ZVS condition, with the ZVS condition being defined by switching the switch to zero voltage; and
a4) determining an optimized value of the internal phase shift (α_{1,OPT}) of the reference port, with said optimized value corresponding to an overall extremum of the set of at least one power parameter; and
b) updating the switching controls for the switches as a function of the optimized values of the internal phase shift (α_{i,OPT}) and of the external phase shift (φ_{i,OPT}) of all the ports, with the optimized values of the internal phase shift (α_{i,OPT}) and of the external phase shift (φ_{i,OPT}) being computed based on the optimized value of the internal phase shift (α_{1,OPT}) of the reference port.

2. The method according to claim 1, wherein the total losses (P_{total losses}) of the converter correspond to the sum of the conduction losses (P_{cond,i}) on all the ports of the converter and of the switching losses (P_{sw,i}) on all the ports of the converter.

3. The method according to claim 1, wherein the set of at least one power parameter only corresponds to the total losses (P_{total losses}) of the converter, the optimized value of the internal phase shift (α_{1,OPT}) of the reference port corresponds to a local minimum of the total losses (P_{total losses}) of the converter.

4. The method according to claim 1, wherein the set of at least one power parameter corresponds to the total losses (P_{total losses}) of the converter and to the number of switches of the converter in the ZVS condition, the optimized value of the internal phase shift (α_{1,OPT}) of the reference port corresponds to a maximum of the number of switches of the converter in the ZVS condition.

5. The method according to claim 4, wherein, if there are at least two maxima of the number of switches of the converter in the ZVS condition, the optimized value of the internal phase shift (α_{1,OPT}) of the reference port corresponds to a local minimum of the total losses (P_{total losses}) of the converter, from among the at least two maxima of the number of switches of the converter in the ZVS condition.

6. The method according to claim 1, comprising, between sub-steps a2) and a3), a sub-step a21) comprising detecting at least one external phase shift (φ_{iMPS}) with a value that is strictly greater than 37°, with the method not comprising a step of updating the switching instants of the switches if at least one external phase shift (φᵢ) with a value that is strictly greater than 37° is detected.

7. The method according to claim 1, comprising a step a0) of resetting the value of the internal phase shift (αᵢ) of all the ports to zero and of assigning an external phase shift value (φᵢ) that is computed by external phase shift modulation.

8. The method according to claim 1, wherein the optimized values of the external phase shift (φ_{i,OPT}) are transmitted to a proportional integral controller before step b).

9. The method according to claim 1, wherein the condition for eliminating the exchange of reactive power between two ports is defined by the following formula:
$$\frac{{V}_{i}}{{n}_{1 i}} \cdot cos ( \frac{{α}_{i}}{2} ) = \frac{{V}_{j}}{{n}_{1 j}} \cdot cos ( \frac{{α}_{j}}{2} ) ,$$
where
Vᵢ and Vⱼ respectively correspond to the DC voltage on the terminals of the ports i and j;
αᵢ and αⱼ respectively correspond to the internal phase shift of the ports i and j;
n₁ᵢ and n₁ⱼ respectively correspond to the turn ratio between the port i and the reference port, and to the turn ratio between the port j and the reference port.

10. The method according to claim 1, wherein the switching controls for the switches are updated provided that a change in voltage or a desired power value at the terminals of at least one of the ports has been detected.

11. The method according to claim 1, wherein the desired power values (Pᵢ) are determined based on a k-order generalized harmonic approximation model, and wherein k=7 for computing the total losses (P_{total losses}) of the converter, and k=101 for computing the number of switches of the converter in the ZVS condition.

12. A device for controlling switches of a multiple active bridge converter comprising n ports, the device being configured to:
a) scan between 0 and π of the value of the internal phase shift (α₁) of a port, called reference port, and, for each value of the internal phase shift (α₁) of the reference port, being configured to:
a1) compute, for each of the n−1 ports different from the reference port, the internal phase shift (αᵢ) by applying a condition for eliminating the exchange of reactive power between the ports, based on the voltage measured at the terminals of the ports;
a2) compute, for each of the n−1 ports different from the reference port, the external phase shift (φᵢ) based on constraints on desired power values (Pᵢ) on each of said n−1 ports different from the reference port;
a3) compute a set of at least one power parameter comprising the total losses (P_{total losses}) of the converter and, optionally, the number of switches of the converter in the ZVS condition; and
a4) determine an optimized value of the internal phase shift (α_{1,OPT}) of the reference port, with said optimized value corresponding to an overall extremum of the set of at least one power parameter; and
b) update the switching controls for the switches as a function of the optimized values of the internal phase shift (α_{i,OPT}) and of the external phase shift (φ_{i,OPT}) of all the ports, with the optimized values of the internal phase shift (α_{i,OPT}) and of the external phase shift (φ_{i,OPT}) being computed based on the optimized value of the internal phase shift (α_{1,OPT}) of the reference port.

13. A conversion system, comprising a multiple active bridge converter and comprising n ports, and further comprising a control device according to claim 12.
